(19) United States
(12) Patent Application Publication
(10) Pub. No.: US 2015/0106914 A1
(43) Pub. Date: Apr. 16, 2015

(54) REMOTE CONTROL SYSTEM, AND METHOD THEREOF

(71) Applicant: POWER-ALL NETWORKS LIMITED, Shatin (HK)

(72) Inventor: STEVE LAP WAI HUI, Shatin (HK)

(21) Appl. No.: 14/511,414

(22) Filed: Oct. 10, 2014

(30) Foreign Application Priority Data
Oct. 16, 2013 (CN) 201310482084.2

(51) Int. Cl. H04L 29/06; H04L 12/24

(52) U.S. Cl. CPC H04L 63/0272; H04L 41/0803
USPC 726/15; 709/220

(57) ABSTRACT

A remote control method includes: assigning network address for a terminal device when the terminal device connects to a terminal connection device; obtaining an identifier code of the terminal connection device or a client connection device when the terminal connection device or the client connection device connects to a remote control server; obtaining terminal device information including network addresses and names of the terminal devices connected to the terminal connection device; storing the terminal information into the remote control server associated with the identifier code of the terminal connection device; determining a client connection device with the same identifier code as the terminal connection device and producing a terminal device list when the user produces a control request via a control device; and controlling the control device to connect to a selected terminal device in response to an operation to select the terminal device on the terminal device list.

### CROSS-REFERENCE TO RELATED APPLICATIONS

This application claims priority to Chinese Patent Application No. 201310482084.2 filed on Oct. 16, 2013, the contents of which are incorporated by reference herein.

### FIELD

The present disclosure relates to control systems, and particularly to a remote control system, and a method thereof

### BACKGROUND

Usually, when a user turns on an electronic device such as a computer at a place (such as home, office) to perform a task, the user may go out for a temporary duty, such as visiting a client in another city. Thus, the user may be hope to monitor the task perform by the electronic device via remote control. However, the usual remote control method is complex and time consuming.

### BRIEF DESCRIPTION OF THE DRAWINGS

Implementations of the present technology will now be described, by way of example only, with reference to the attached figures.

FIG. 1 is a block diagram of a remote control system.

FIG. 2 is a diagrammatic view of a remote control device connected to a terminal connection device and a client connection device.

FIG. 3 is a flowchart diagram of an information collection method of a remote control method.

FIG. 4 is a flowchart diagram of a connection control method of a remote control method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like. The connection can be such that the objects are permanently connected or releasably connected or physical connected or communicably connected.

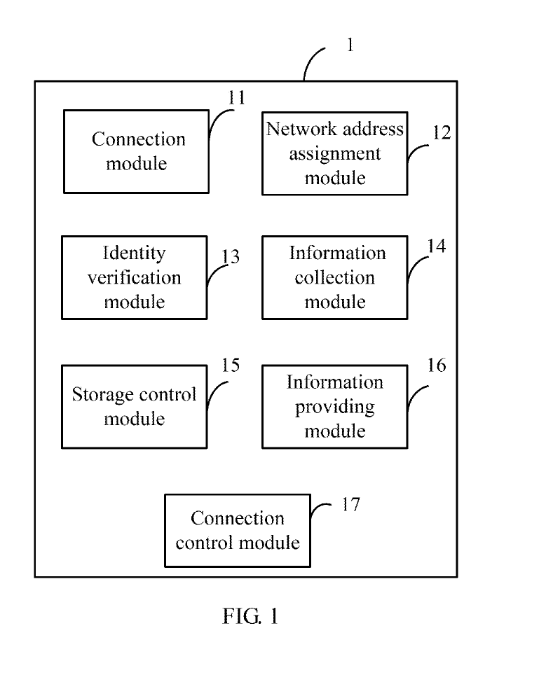

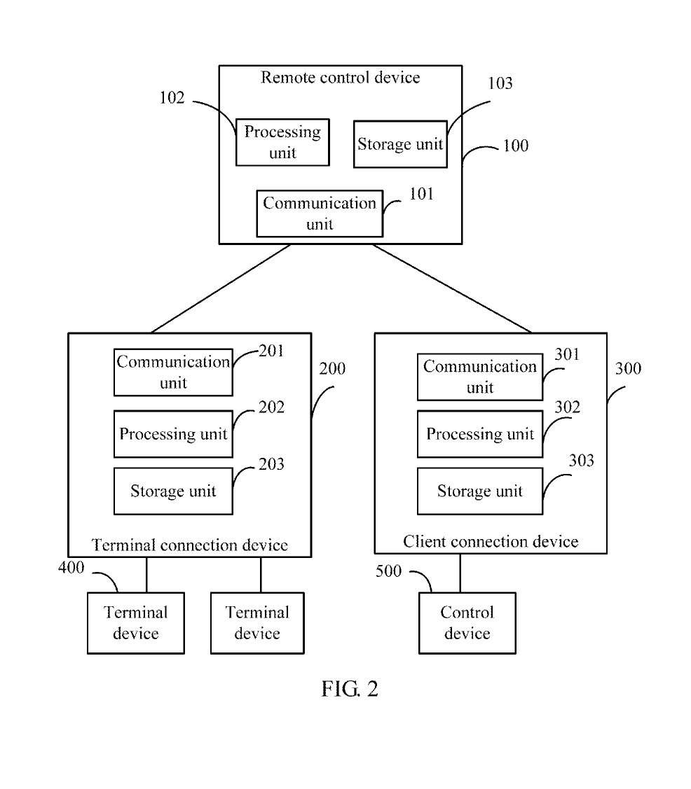

Referring to FIGS. 1 and 2, a remote control system 1 is illustrated. The remote control system 1 is run in a hardware environment including at least one remote control server 100, at least terminal connection device 200, and at least one client connection device 300 as shown in FIG. 2.

The remote control server 100 includes a communication unit 101, a processing unit 102, and a storage unit 103. The terminal connection device 200 includes a communication unit 201, a processing unit 202, and a storage unit 203. The client connection device 300 includes a communication unit 301, a processing unit 302, and a storage unit 303. The communication unit 101 of the remote control server 100 is connected to the communication unit 201 of the terminal connection device 200 and the communication unit 301 of the client connection device 300 via a corresponding network. The network can be Internet, a virtual private network (VPN), virtual lease line, or the like. The communication units 101, 201, 301 can be wired communication modules, such as, network cards, or can be wireless communication modules, such as cellular telephone cards, WIFI modules.

The terminal connection device 200 is used to communicably connect to at least one terminal device 400. In one embodiment, the terminal connection device 200 can be set in a home or an office to connect to the terminal device 400 located in the home or the office. The client connection device 300 is used to connect to at least one control device 500 carried by a user when the user goes out to do something, such as visiting a client in another city. The client connection device 300 can be set on another place different from the terminal connection device 200, such as a hotel, another office. In the embodiment, the terminal connection device 200 and the client connection device 300 both can be routers, switches, or the like. The terminal device 400 and the control device 500 can be mobile phones, computers include, but not limited to portable computers, tablet computers, desktop computers, and servers. The remote control server 100 can be a server or a server group, and can be a virtual machine or a physical machine.

The remote control system 1 includes a connection module 11, a network address assignment module 12, an identity verification module 13, an information collection module 14, a storage control module 15, an information providing module 16, and a connection control module 17. In the embodiment, the connection module 11 and the network address assignment module 12 can be collections of software instructions stored in the storage unit 203 of the terminal connection device 200 and executed by the processing unit 202 of the terminal connection device 200. The identity verification module 13, the information collection module 14, the storage control module 15, the information providing module 16, and the connection control module 17 can be collections of software instructions stored in the storage unit 103 of the remote control server 100 and executed by the processing unit 102 of the remote control server 100. The connection module 11 also can be a collection of software instructions stored in the storage unit 303 of the client connection device 300 and executed by the processing unit 302 of the client connection device 300. The modules of the remote control system 1 also can include functionality represented as hardware or integrated circuits, or as software and hardware combinations, such as a special-purpose processor or a general-purpose processor with special-purpose firmware.

In another embodiment, the all of modules of the remote control system 1 can be stored in the storage unit 103 of the remote control server 100 and executed by the processing unit 102 of the remote control server 100.

In one embodiment, each one of the processing units 102, 202, and 302 can be a central processing unit, a digital signal processor, or a single chip, for example. In one embodiment, each one of the storage units 103, 203, and 303 can be an internal storage system, such as a flash memory, a random access memory (RAM) for temporary storage of information, and/or a read-only memory (ROM) for permanent storage of information. Each one of the storage units 103, 203, and 303 can also be a storage system, such as a hard disk, a storage card, or a data storage medium. Each one of the storage units 103, 203, and 303 can include volatile and/or non-volatile storage devices. In at least one embodiment, each one of the storage units 103, 203, and 303 can include two or more storage devices such that one storage device is a memory and the other storage device is a hard drive. Additionally, one or more of the storage units 103, 203, and 303 can be respectively located either entirely or partially external relative to the remote control server 100, the terminal connection device 200, and the client connection device 300.

The connection module 11 is used to communicably connect the terminal connection device 200 to the remote control server 100 upon the terminal connection device 200 is started up, thus to establish the communicably connection between the terminal connection device 200 and the remote control server 100.

The network address assignment module 12 is used to assign a corresponding network address to a terminal device 400 and associate the network address with a name of the corresponding terminal device 400 when determining the terminal connection device 200 connects the terminal device 400. In the embodiment, the network address can be an Internet protocol (IP) address. In detail, when the terminal connection device 200 is the router, the network address can be an IP addresses within an IP address range provided by the terminal connection device 200. The name of the terminal device 400 can be a model number of the terminal device 400, or a name defined by the user of the terminal device 400. In the embodiment, the network address assignment module 12 obtains the name of the terminal device 400 at the moment of the terminal connection device 200 connects to the terminal device 400.

The identity verification module 13 is used to obtain a first identifier code sent by the terminal connection device 200 when the terminal connection device 200 communicably connects to the remote control server 100.

The information collection module 14 is used to collect information of each terminal device 400 connected to the terminal connection device 200 after the terminal connection device 200 is communicably connected to the remote control server 100. The information of each terminal device 400 includes the network address and the name of each terminal device 400.

The storage control module 15 is used to store the network address and the name of each terminal device 400 and the identifier code of the terminal connection device 200 connected to the terminal device 400 into the storage unit 103 of the remote control server 100, and associate the network address and the name of each terminal device 400 with the identifier code of the terminal connection device 200.

In the embodiment, the connection module 11 further communicably connects the client connection device 300 to the remote control server 100 upon the client connection device 300 is started up.

The identity verification module 13 further obtains a second identifier code sent by the client connection device 300 upon the client connection device 300 is communicably connected to the remote control server 100.

In the embodiment, when the terminal connection device 200 and the client connection device 300 are a pair of devices mate to each other and owned by the same user, the first identifier code and the second identifier code are the same. In one embodiment, the first identifier code or the second identifier code can be a VPN verification file and is used to verify the identities of the terminal connection device 200 and the client connection device 300 when the terminal connection device 200 and the client connection device 300 communicably connect to the remote control server 100 to establish the VPN. In one embodiment, the identity verification module 12 further verifies the identities of the terminal connection device 200 and the client connection device 300 via the first identifier code or the second identifier, thus to establish the VPN. The terminal connection device 200 and the mated client connection device 300 use the same VPN verification file to connect the remote control device 100, therefore, the first identifier code sent by the terminal connection device 200 and the second identifier sent by the mated client connection device 300 are the same.

In another embodiment, the first identifier code sent by the terminal connection device 200 and the second identifier sent by the client connection device 300 are product serial numbers of the terminal connection device 200 and the client connection device 300. When the terminal connection device 200 and the client connection device 300 are a pair of devices mate to each other, the product serial numbers of the terminal connection device 200 and client connection device 300 are the same. The identifier code sent by the terminal connection device 200 and the second identifier sent by the client connection device 300 are also can be any mated code previous assigned to the terminal connection device 200 and the client connection device 300 mated to each other.

The information providing module 16 is used to receive a remote control request from one client connection device 300, and determine the terminal connection device 200 with the same identifier code as that of the client connection device 300. The information providing module 16 further provides a terminal device list to the control device 500 connected to the client connection device 300 according to the terminal devices connected to the terminal connection device 200. The terminal device list can include a list of names of all of the terminal devices connected to the terminal connection device 200.

In detail, when the user is going out, the user can connect the control device 500 to the client connection device 300 and communicate with the remote control server 100 to submit the remote control request. The information providing module 16 obtains the identifier code of the client connection device 300, and determines the terminal connection device 200 with the same identifier code as that of the client connection device 300, and further obtains the names of the terminal devices 400 connected to the terminal connection device 200, thus to provide the terminal device list including the name of the terminal devices 400 to the control device 500.

The connection control module 17 is used to determine a selected terminal device 400 according to a selection on the terminal device list operated by the user of the control device 500. The connection control module 17 further determines the network address of the selected terminal device 400 and controls the control device 500 to communicably connect to the selected terminal device 400 according to the network address of the terminal device 400. Therefore, after the control device 500 is connected to the selected terminal device 400, the control device 500 can control the selected terminal device remotely. In detail, the connection control module 17 determines the name of the terminal device 400 selected by the user from the terminal device list, and determines the network address of the selected terminal device associated with the name, and controls the control device 500 to communicably connect to the selected terminal device according to the network address of the terminal device.

According to the present disclosure, before the user goes out, the user can first connect the terminal device 400 to be controlled to the terminal connection device 200, and when the user goes to another place, the user can connect the control device 500 to the corresponding client connection device 300, thus to control the terminal device 400 connected to the terminal connection device 200 by using the control device 500 connected to the client connection device 300.

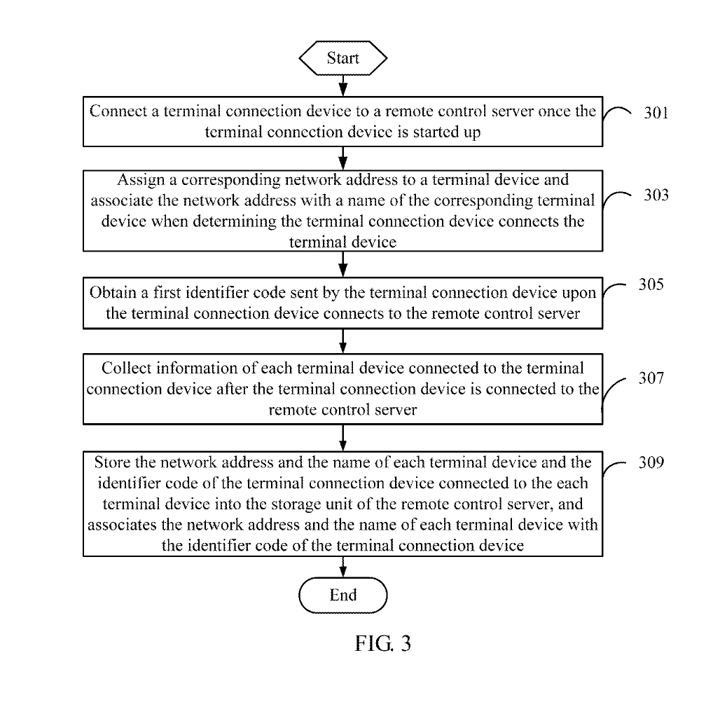

FIG. 3 illustrates a flowchart of an information collection method of a remote control method. The method is provided by way of example, as there are a variety of ways to carry out the method. The method described below can be carried out using the configurations illustrated in FIGS. 1 and 2, for example, and various elements of these figures are referenced in explaining the example method. Each block shown in FIG. 3 represents one or more processes, methods, or subroutines carried out in the example method. Additionally, the illustrated order of blocks is by example only and the order of the blocks can be changed. The example method can begin at block 301.

In block 301, a connection module communicably connects a terminal connection device to a remote control server upon the terminal connection device is started up.

In block 303, a network address assignment module assigns a corresponding network address to a terminal device and associates the network address with a name of the corresponding terminal device when determining the terminal connection device connects the terminal device.

In block 305, an identity verification module obtains a first identifier code sent by the terminal connection device upon the terminal connection device communicably connects to the remote control server.

In block 307, an information collection module collects information of each terminal device connected to the terminal connection device after the terminal connection device is communicably connected to the remote control server. The information of each terminal device includes the network address and the name of each terminal device.

In block 309, a storage control module stores the network address and the name of each terminal device and the identifier code of the terminal connection device connected to the each terminal device into the storage unit of the remote control server, and associates the network address and the name of each terminal device with the identifier code of the terminal connection device.

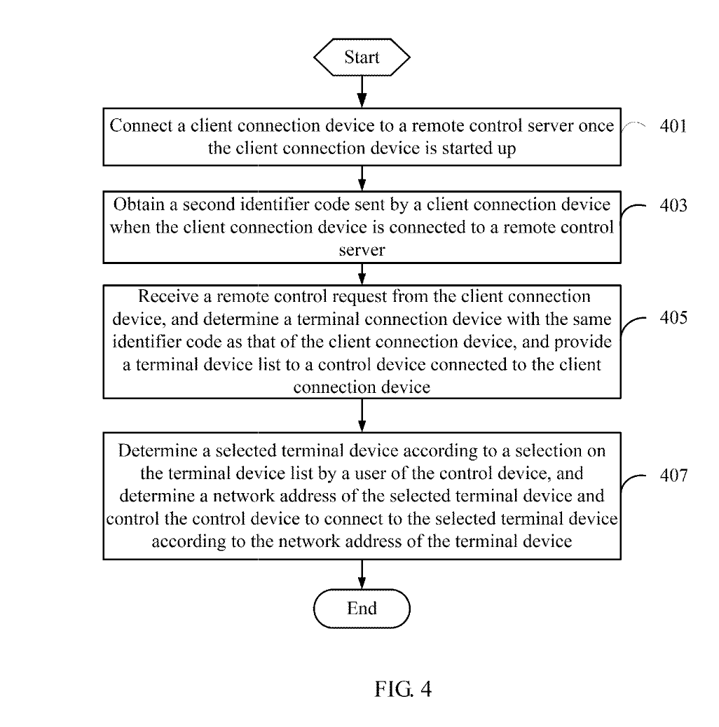

FIG. 4 illustrates a flowchart of a connection control method of the remote control method. The method is provided by way of example, as there are a variety of ways to carry out the method. The method described below can be carried out using the configurations illustrated in FIGS. 1 and 2, for example, and various elements of these figures are referenced in explaining the example method. Each block shown in FIG. 4 represents one or more processes, methods, or subroutines carried out in the example method. Additionally, the illustrated order of blocks is by example only and the order of the blocks can be changed. The example method can begin at block 401.

In block 401, a connection module connects a client connection device to a remote control server upon the client connection device is started up.

In block 403, an identity verification module obtains a second identifier code sent by a client connection device upon the client connection device is communicably connected to a remote control server.

In block 405, an information providing module receives a remote control request from the client connection device, and determines a terminal connection device with the same identifier code as that of the client connection device, and provides a terminal device list to a control device communicably connected to the client connection device according to the terminal devices connected to the terminal connection device. The terminal device list can include a list of names of all of the terminal devices connected to the terminal connection device.

In block 407, a connection control module determines a selected terminal device according to a selection on the terminal device list by a user of the control device, and determines a network address of the selected terminal device and controls the control device to communicably connect to the selected terminal device according to the network address of the terminal device.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A remote terminal control system comprising:
at least one processing unit; and
at least one storage unit, the at least one storage unit storing a plurality of modules executable by the at least one processing unit;
wherein, the plurality of modules comprises:
a connection module configured to communicably connect a terminal connection device to a remote control server upon the terminal connection device is started up, and configured to communicably connect a client connection device to the remote control server upon the client connection device is started up;
a network address assignment module configured to assign a corresponding network address to a terminal device and associate the corresponding network address with a name of the terminal device upon the terminal device is communicably connected to the terminal connection device
an identity verification module configured to obtain a first identifier code sent by the terminal connection device when the terminal connection device communicably connects with the remote control server, or a second identifier code sent by the client connection device when the client connection device communicably connects with the remote control server;
an information collection module configured to collect information of each terminal device connected to the terminal connection device after the terminal connection device is connected to the remote control server, the collected information of each terminal device including the network address and name of the terminal device;
a storage control module configured to store the network address and the name of the terminal device and the identifier code of the terminal connection device into a storage unit of the remote control server, and associate the network address and the name of the terminal device with the identifier code of the terminal connection device;
an information providing module configured to receive a remote control request from a client connection device, determine the terminal connection device with the same identifier code as that of the client connection device and provide a terminal device list to a control device connected to the client connection device according to the connected terminal device; and
a connection control module configured to determine a selected terminal device according to a selection on the terminal device list by a user of the control device, and determine the network address of the selected terminal device and control the control device to communicably connect to the selected terminal device according to the network address of the terminal device.

2. The system according to claim 1, wherein the name of the terminal device is a model number of the terminal device or a name defined by a user of the terminal device.

3. The system according to claim 2, wherein the terminal device list comprises a list of names of all of the terminal devices connected to the terminal connection device, the connection control module determines the name of the terminal devices selected by the user from the terminal device list, and determines the network address of the selected terminal device associated with the name, and controls the control device to connect to the selected terminal device according to the network address of the terminal device.

4. The system according to claim 1, wherein the first identifier code sent by the terminal connection device and the second identifier code sent by the client connection device are virtual private network (VPN) verification files and are configured to verify the identities of the terminal connection device and the client connection device when the terminal connection device and the client connection device connect to the remote control server to establish the VPN; when the terminal connection device and the client connection device are a pair of devices mated to each other, the identifier codes of the terminal connection device and the client connection device are the same.

5. The system according to claim 1, wherein the first identifier code sent by the terminal connection device and the second identifier code sent by the client connection device are product serial numbers of the terminal connection device and the client connection device; when the terminal connection device and the client connection device are a pair of devices mated to each other, the product serial numbers of the terminal connection device and client connection device are the same.

6. The system according to claim 1, wherein the network address of the terminal device is an Internet protocol address.

7. A remote control method comprising:
connecting a terminal connection device to a remote control server upon the terminal connection device is started up;
assigning a corresponding network address to one terminal device and associating the network address with a name of the corresponding terminal device upon determining the terminal device is communicably connected to the terminal connection device;
obtaining a first identifier code sent by the terminal connection device;
collecting information of each terminal device communicably connected to the terminal connection device after the terminal connection device is connected to the remote control server, wherein the information of each terminal device comprises a network address and a name of the terminal device;
storing the network address and the name of each terminal device and the identifier code of the terminal connection device connected to the terminal device into a storage unit of the remote control server, and associating the network address and the name of each terminal device with the identifier code of the terminal connection device;
connecting the client connection device to the remote control server upon the client connection device is started up;
obtaining a second identifier code sent by a client connection device upon the client connection device communicably connects to the remote control server;
receiving a remote control request from one client connection device, and determining the terminal connection device with the same identifier code as that of the client connection device, and providing a terminal device list to the control device connected to the client connection device according to the terminal devices communicably connected to the terminal connection device; and
determining a selected terminal device according to a selection on the terminal device list by a user of the control device, and determining the network address of the selected terminal device and controlling the control device to communicably connect to the selected terminal device according to the network address of the terminal device.

8. The method according to claim 7, wherein the name of the terminal device is a model number of the terminal device or a name defined by a user of the terminal device.

9. The method according to claim 7, wherein the terminal device list comprises a list of names of all of the terminal devices connected to the terminal connection device, the step of determining a selected terminal device according to a selection on the terminal device list by a user of the control device, and determining the network address of the selected terminal device and controlling the control device to communicably connect to the selected terminal device according to the network address of the terminal device comprising:
determining the name of the terminal devices selected by the user from the terminal device list;
determining the network address of the selected terminal device associated with the name; and
controlling the control device to communicably connect to the selected terminal device according to the network address of the terminal device.

10. The method according to claim 7, wherein first identifier code of the terminal connection device and the second identifier code of the client connection device are virtual private network (VPN) verification files, the method further comprising:
verifying identities of the terminal connection device and the client connection device according to the private network (VPN) verification files when the terminal connection device and the client connection device connect to the remote control server to establish the VPN.

11. A non-transitory storage medium having stored thereon instructions that, when executed by at least one processor, causes the least one processor to execute instructions of a method for automatically control a terminal device by remote, the method comprising:
connecting a terminal connection device to a remote control server upon the terminal connection device is started up;
assigning a corresponding network address to one terminal device and associating the network address with a name of the corresponding terminal device upon determining the terminal device is communicably connected to the terminal connection device;
obtaining a first identifier code sent by the terminal connection device;
collecting information of each terminal device communicably connected to the terminal connection device after the terminal connection device is connected to the remote control server, wherein the information of each terminal device comprises a network address and a name of the terminal device;
storing the network address and the name of each terminal device and the identifier code of the terminal connection device connected to the terminal device into a storage unit of the remote control server, and associating the network address and the name of each terminal device with the identifier code of the terminal connection device;
connecting the client connection device to the remote control server upon the client connection device is started up;
obtaining a second identifier code sent by a client connection device upon the client connection device communicably connects to the remote control server;
receiving a remote control request from one client connection device, and determining the terminal connection device with the same identifier code as that of the client connection device, and providing a terminal device list to the control device connected to the client connection device according to the terminal devices communicably connected to the terminal connection device; and
determining a selected terminal device according to a selection on the terminal device list by a user of the control device, and determining the network address of the selected terminal device and controlling the control device to communicably connect to the selected terminal device according to the network address of the terminal device.

12. The non-transitory storage medium according to claim 11, wherein the name of the terminal device is a model number of the terminal device or a name defined by a user of the terminal device.

13. The non-transitory storage medium according to claim 11, wherein the terminal device list comprises a list of names of all of the terminal devices connected to the terminal connection device, the step of determining a selected terminal device according to a selection on the terminal device list by a user of the control device, and determining the network address of the selected terminal device and controlling the control device to communicably connect to the selected terminal device according to the network address of the terminal device comprising:
determining the name of the terminal devices selected by the user from the terminal device list;
determining the network address of the selected terminal device associated with the name; and
controlling the control device to communicably connect to the selected terminal device according to the network address of the terminal device.

14. The non-transitory storage medium according to claim 11, wherein first identifier code of the terminal connection device and the second identifier code of the client connection device are virtual private network (VPN) verification files, the method further comprising:
verifying identities of the terminal connection device and the client connection device according to the private network (VPN) verification files when the terminal connection device and the client connection device connect to the remote control server to establish the VPN.
